(19) United States
(12) Patent Application Publication
(10) Pub. No.: US 2005/0026121 A1
(43) Pub. Date: Feb. 3, 2005

(54) Multimedia social skills training

(76) Inventor: Christoph H. Leonhard, River Forest, IL (US)

Correspondence Address: Edward K. Runyan;McDonnel Boehnen Hulbert & Berghoff, 32nd Floor, 300 S. Wacker Drive, Chicago, IL, 60606, US

(21) Appl. No.: 10/630,346

(22) Filed: Jul. 30, 2003

(51) Int. Cl. G09B 19/00

(52) U.S. Cl. 434/238

(57) ABSTRACT

A behavioral training tool and a method for making and using the tool. The tool is produced by making a recording of an interaction between a first person and an entity, where the recording may include information from both the first person and the entity. An evaluation of the interaction may be generated contemporaneously or subsequent to the recording. The recording and the evaluation may be combined to produce a product, such as a multimedia program that can be observed by a user to train the user to recognize qualities of the interaction. The user may make inputs to a system that includes the product, and the inputs can be compared to the evaluation for teaching and assessment purposes.

### BACKGROUND

1. Field of the Invention

The present invention relates to social skills training and, more particularly, to a multimedia product and system for improving social skills.

2. General Background

Behavioral social learning theory and research show that humans learn from consequences that follow their behavior. We show more of a certain behavior if we receive reinforcement and less if we receive no reinforcement or are punished for the behavior. In fluid, ongoing situations this is known as “conjugate reinforcement”. For example, we learn to ski or golf largely through conjugate reinforcement. Some instruction is usually also helpful, but one cannot learn to ski without actually getting on the skis and skiing (or trying to ski).

In adolescent or adult social situations, the process of learning smooth, fluid, and effective social conduct is handicapped because people often go to some length to conceal how they really feel toward another person. Some individuals do not “pick up on” social feedback even if the person giving the feedback is trying to be fairly blunt. Learning appropriate behavior can be even more difficult for certain individuals, such as depressed individuals, since people with whom they interact may give blunted or misleading cues regarding their feelings or thoughts. For example, a person talking to someone who is depressed may offer encouraging words, even when he or she is alienated and “turned off” by the depressed person's constant complaints. Such personal responses can lead to misunderstandings, encourage further complaints, or at least make it more difficult for a depressed person to become more socially likeable due to the difficulty in “reading” conversation cues given by others. Thus, an effective training tool to improve social skills and to discriminate interpersonal conversation cues is needed to teach people greater interpersonal sensitivity and improve interpersonal skill.

### SUMMARY

In one aspect, a method for producing a behavioral training tool is provided. The method may include making a recording of an interaction between a first person and an entity, and the recording may include information (such as audio or video) from the first person and the entity. The method may also include generating at least one evaluation of the interaction and combining the recording and the at least one evaluation to produce a product.

In another aspect, a method of behavioral training using a multimedia training tool is provided. The training tool may include a recorded interaction and an evaluation of the interaction, and the method may include selecting continuous or discrete interaction quality changes to be used to assess a user. The method may further include selecting a perspective of the recorded interaction for the user to observe and starting the multimedia training tool for observation by the user. The user can provide input which represents the user's estimate of at least one quality of the recorded interaction. The user's input can be compared to the evaluation for teaching or assessing the user.

These as well as other aspects of the present system will become apparent to those of ordinary skill in the art by reading the following detailed description, with appropriate reference to the accompanying drawings.

### BRIEF DESCRIPTION OF THE DRAWINGS

Exemplary embodiments of the invention are described below in conjunction with the appended figures, wherein like reference numerals refer to like elements in the various figures, and wherein:

FIG. 1 is a diagram of a communication system in accordance with an exemplary embodiment of the present system;

FIG. 2 is a block diagram of a predictive caching server capable of performing the functions of the present system; and

FIG. 3 is a flow chart illustrating the operation of the present system.

### DETAILED DESCRIPTION

Effective interpersonal communication is very important to one's success, happiness, or both, but there are sometimes many obstacles that make effective communication difficult. These obstacles can include nonverbal aspects, verbal aspects, cultural values and practices, and personality variables.

Effective communication between people is becoming increasingly important, because the United States is moving increasingly to a service-based economy in which excellence in interpersonal sensitivity and skill is highly prized. At the same time, people are spending more time interacting through electronic media, such as TV and the Internet. Such non-personal interaction reduces people's opportunities to acquire and refine their social sensitivity and skill. The present training system is highly adaptable to teach a great variety of interpersonal social and communication skills, such as the skills required for heterosexual dating situations, teenage peer relationships, teenage dating situations, intercultural and cross-cultural communication and sensitivity, sales situations, negotiation training, parent-to-child talks, empathy training, reducing depression, schizophrenia or their effects, and more.

An exemplary embodiment of the present system includes a multimedia training tool. The training tool can be implemented as an interactive, computer-based system that provides a continuously available means for a user to train himself (or assess his) social skills. Broadly, the multimedia tool includes a recorded interaction chosen for its applicability to the intended user (who is viewing or observing the interaction). The tool also includes an “expert” evaluation of the interaction. (The “expert” can be a trained professional or simply one or more participants in the recorded interaction). The tool may allow for user input, where the input represents the user's estimate of the quality of the interaction.

By comparing the user's input to the evaluation, the user can be taught to better recognize communication cues. Teaching the user would likely include feedback on how the user's input compares to the expert evaluation. The system can also be used without feedback to provide an assessment of the user's ability to recognize communication cues that are important for the skills the user is trying to gain.

Creating A Training Tool

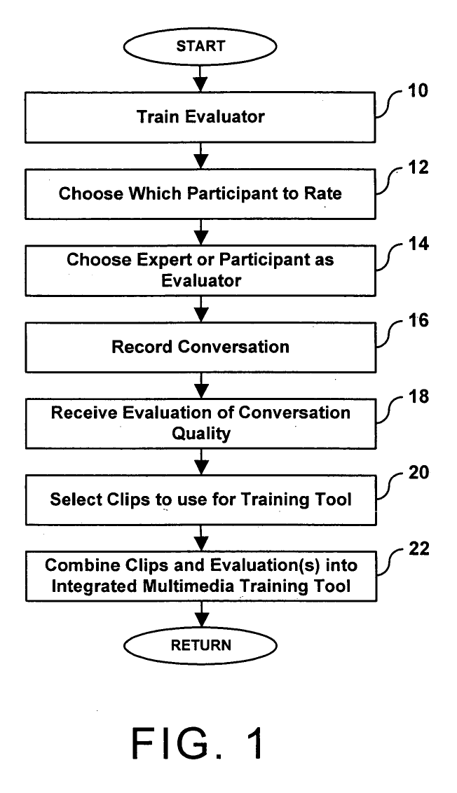

FIG. 1 illustrates a set of steps that may be used to produce an exemplary behavioral “training” tool. It should be noted that assessing the user's present ability to recognize communication cues, and assessing improvement may be considered part of “training”, which also includes the interactive process of a user observing and rating an interaction and receiving immediate or aggregate feedback on one's estimate of the quality of the interaction.

As shown at block 10, a conversation participant or an expert “rater” may be trained prior to recording an interaction. The conversation participant may be a person who belongs to a group or category or type of person with whom a user would like to interact, such as, for example, an African-American male or a European-American Female. The participant or expert may be referred to as a “rater” because he or she may be “rating” or providing an evaluation of the interaction, which can generally be referred to as conversation quality. For example, when a recording is made, a rater may be videotaped and may continuously rate how well he or she feels the conversation is going by manipulating a computer mouse or other input device. The mouse may be connected to a personal computer to receive input, and the personal computer may in turn be communicatively connected with a recorder for synchronization, although synchronization could also be performed after the fact.

Raters may be instructed to move the mouse up or down based on their evaluation of the conversation, where a full “up” position of the joystick could represent a rating of 10 (which could in turn represent the best possible conversation ever experienced). Similarly, raters may be instructed to move the mouse to the full “down” position to indicate 0 (the worst possible conversation), and 5 can represent a rating that is neither good nor bad.

A computer program in the personal computer or accessible via a networksuch as the Internet can be used to teach raters to effectively operate the mouse in advance of making the recording that will be used to train or evaluate people.

Raters may be paid employees, volunteers, or persons with whom later users of the system will interact. For example, it may be extremely helpful for a Russian businessman to train himself to recognize various conversation cues of actual American businessmen he will shortly meet. Similarly, it may be useful for a woman to learn to read the cues of a specific man she is interested in. It is not necessary, however, that raters are people who will eventually meet users of the system. In fact, it is not even necessary for raters to be participants in the conversation that is to be recorded. For instance, raters could be experienced evaluators (or experts) who belong to the same group as a participant. As an illustration, a group of attractive women could evaluate cues given by a woman in a potential dating conversation, or a trained and highly successful expert on selling Automobiles could evaluate a novice salesperson's interaction with a customer.

Once raters can reliably use an input device, a decision can be made regarding which participant or participants in the interaction are to be rated or provide ratings themselves, as shown at block 12. Next, an evaluator can be chosen as shown at block 14. The evaluator, as mentioned above, can be one or more conversation participants, an expert, or any combination of these.

As shown at block 16, an interaction (such as a conversation) between the first person and an entity (which may be a second person, such as a “conversation partner” or a recorded stimulus that is played back or displayed to the first person) is recorded. The task of the entity or second person is to carry on a conversation with the rater. In some instances both participants may rate the conversation, so that a recorded interaction showing either or both participants can be used for training. The content of the particular conversation to be recorded is not especially important. It is more important that any recorded conversations include a great variety of conversation quality scores, with regard to level, slope of trend, and direction of trend.

It is not necessary that participants in the conversation are even aware of the ultimate purpose of the recording. In an experiment of one part of the system, participants were simply given the following instructions, or their equivalent:
“In a minute you will be introduced by the experimenter to a student. Please pretend that you have just been introduced by a mutual friend who left the two of you to talk by yourselves. You may talk about anything you wish. However, please follow these guidelines:
1) Do not give out your last name.
2) Do not give out your address, telephone number, or any other information you consider personal.
3) Do not discuss the study or your participation in it.
While you are talking you will be videotaped. Please also rate the quality of the conversation while it is ongoing. You do this by positioning the computer joystick which you will hold concealed under the table. Remember to rate the conversation on an imaginary percentage scale from 0% to 100%, with 0% being the worst conversation you ever had and 100% being the best conversation you ever had. Remember that your conversation partner knows you are doing this, and has agreed to have this conversation rated by you. Your conversation partner will never get access to these ratings. It is extremely important that you are absolutely honest in your rating at all times. Your conversation partner will never find out how you rated the conversation. If you are not willing to be absolutely honest in your ratings, then please withdraw from the study now.”

As mentioned, any combination of perspectives may be recorded for maximum flexibility. For example, the first person or rater could be recorded, while the second person remains unseen. If the other participant in the interaction is a person and if the ratings are to be collected contemporaneously with the recording, the input device may be hidden. For other applications, it may be useful to record the second person while the first person remains unseen. For example, if one person is a heterosexual male and the other a heterosexual female, a recording that shows the heterosexual female could be used to train sensitivity in heterosexual males while a recording that shows the heterosexual male could be used to train sensitivity in heterosexual females. A recording that shows heterosexual females could be used to vicariously train skill in heterosexual females, while a recording that shows heterosexual males could be used to vicariously train skill in heterosexual males.

If an expert who is not a conversation participant is to evaluate the quality of the recorded conversation, the recorded conversation may be shown to the expert, although the expert could also produce an evaluation at the time the conversation occurs. In addition to contemporaneous participant evaluation of the conversation, participants could provide an evaluation after the conversation has ended by viewing a videotape or digital video of the conversation and then providing a synchronous evaluation of how they would rate the conversation.

Evaluations can be received by recording mouse or input device position at a rate of, for example, one sample per second. Block 18 shows the function of receiving evaluator's inputs regarding their estimate(s) of conversation quality. The evaluation, along with other necessary data, can be stored as a track that indicates ratings that vary over time, synchronized with the recorded conversation so that a high or low conversation quality rating would always correspond to what is happening in the conversation.

Recorded conversations may be somewhat long relative to the recorded clips that will ultimately be used in the training tool. This allows videos to be edited based on their content and based on underlying evaluations of conversation quality to produce useful discrete portions (clips) of the conversation that are about 2-3 minutes long, as illustrated at block 20. Portions of recorded conversations that are not selected may be discarded.

At block 22, the recording and the evaluation can be combined to produce a multimedia training product. The product may take the form of an interactive tool stored on a computer readable or other medium. For example, the final product may be a DVD, a CD-ROM, or it may simply be a recording of synchronous information on a hard disk or analog medium, such as VHS tape. The final product may be used locally by playing back the recording directly on a computer. Alternatively, the product may be accessed remotely via the Internet. The training tool will include the selected clip from the audio/video recording of the interaction in analog, digital, or compressed digital form. The tool will also include the synchronous evaluation or evaluations of the conversation and may include program instructions to accept user input and compare the input to the evaluation(s). Alternatively, program instructions to use the tool may be a separate component of the tool used to access synchronized clips and evaluations stored on a computer readable medium. The tool may contain multiple perspectives as mentioned above to enable users to view either side of a conversation, or even both sides at once.

To produce the product, an established multimedia training tool such as ToolBook, from click2learn.com, Inc., may be used. If the Internet is to be used when accessing the training program, the media to be employed for training can be stored in an Internet compatible media file format, and whether stored locally or remotely for Internet use, the training tool can be operated from a user's Internet browser on a PC. In operation, the tool may be presented as an audio/video presentation that occupies all or a portion of the user's computer screen.

Using The Training Tool

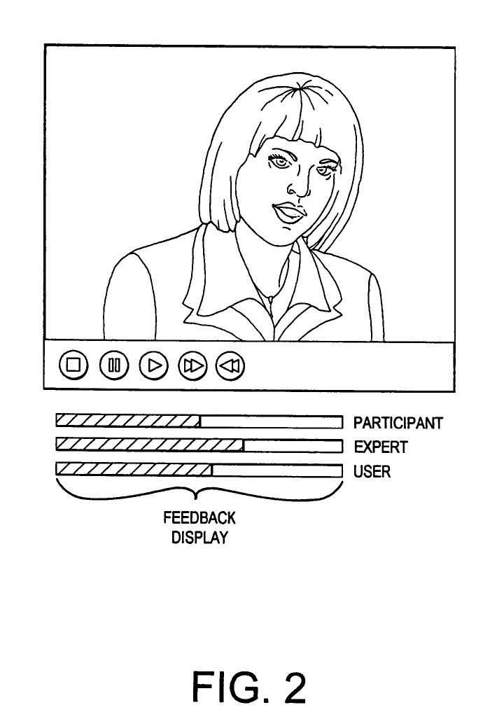

As shown in FIG. 2, the tool may present to the user icons to control the presentation of the training, and a visual indicator of the user's input. As a brief example of the training tool's use, a user could initiate the training program and then “click” the right “PLAY” arrow beneath the video display portion. As the user views a recorded clip or clips, he may indicate his estimate of the quality of the conversation by moving his mouse to the left or right (or otherwise provide an input), and a VU meter-type bar graph, as shown, can display his input. A VU meter-type graph can also (optionally, depending on the mode of the tool) synchronously display participant and expert evaluations along with the user's input.

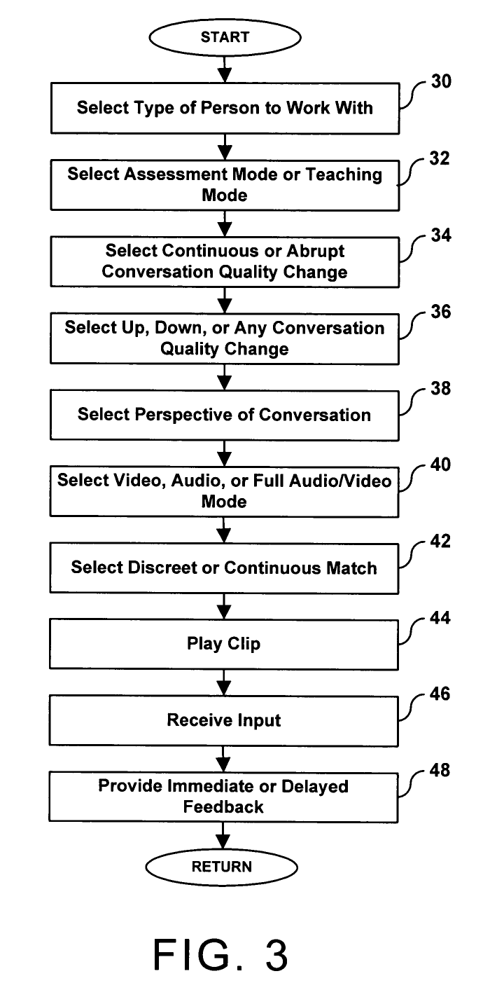

FIG. 3 illustrates a set of functions that may be used for teaching a user or assessing a user's sensitivity to conversational cues using the tool. At block 30, the user can manually select the type of person to work with, such as an American female. Next, as shown at block 32, the user may select training mode or assessment mode, or the tool may present the user with a recommendation based on a record of the user's past training stored in a memory associated with the system. For example, the user's computer may store records of training locally, or records may be stored remotely for Internet-based training.

Teaching Mode

If teaching mode is selected, any of various training styles can be selected prior to beginning a training session. Accordingly, the user (or another person, an automatic function, or the tool default) may select continuous or abrupt conversation quality change as shown at block 34, up or down or any quality change (block 36). The perspective (see block 38) from which to view the conversation may be selected as well as video only, audio only, or audio and video (block 40). A selection between video only, audio only, or audio and video will allow or require a user to focus only on the available conversation cues.

For example, in a heterosexual dating situation, a male user may first select to view a conversation clip from the male participant's perspective—that is, viewing a female. For subsequent sessions, the user may wish to return to the clip and view it from the opposite perspective to determine what a man talking to a woman did wrong, and what he did right, in order to facilitate vicarious learning.

For initial training, the user may use the tool without providing input. Specifically, the user can choose to view clips with audio indications (feedback) of the evaluation, video indications, or a combination of audio and video feedback.

Next, the user may specify the type of training desired, such as discrete match or continuous match, shown at block 42. If continuous changes are to be measured, the user could provide continuous input, and training or evaluation could be done on the basis of quality level, the slope of the quality trend, and the direction of the trend. If discrete changes are to be used, the user would simply indicate points during the conversation where he believes a significant change in the conversation quality has occurred. Such significant, pivotal changes may be thought of as either “bloopers” or “home runs”.

Once any desired selections are made, clip playback can be started (block 44) and user input (block 46) can be received and recorded by the multimedia tool. The user input can be used for either teaching mode or assessment mode. The user's estimate of conversation quality can be compared to the participant's or expert's evaluation of the conversation being presented. This comparison can be used to provide immediate or delayed feedback to the user, as shown at block 48. Immediate feedback could be in the form of an audio signal such as a varying pitch tone, a varying click rate, or any other suitable form. For example, the better the user's estimate of the conversation quality as compared to the evaluation, a tone's pitch could go higher, or a click rate could increase, simulating a Geiger counter, metal detector or radar detector. In such a “biofeedback” mode, a higher tone could mean the user's estimate is higher than the evaluator's estimate of conversation quality; a lower tone could mean the user's estimate is too low, and no tone could mean the user's estimate matches, within limits, the evaluator's estimate.

Feedback can also be given after all of the user's input for a particular session (e.g., one clip of a recorded conversation) is received. For example, after a user has viewed a clip and provided input, the clip can be shown to the user while a visual indication of both the user's input and the evaluator's input are displayed simultaneously. Such a display could take the form of one bar graph on top of (or beside) another, as shown in FIG. 2, and may or may not be accompanied by audio feedback.

Correspondence between the user's estimate and the evaluation can either be done parametrically, non-parametrically based on input ratings, and parametrically based on other criteria, such as a participant's post-conversation feedback (e.g., a written evaluation of the overall quality of the conversation). Several methods for calculating correspondence for teaching and assessment are described below, but it should be noted that many other methods are possible within the scope of the appended claims.

Parametric calculation of user input data can be made in a computer to which a joystick or other input device is connected, for example, once per second using the following algorithm:
1) If the user's score is the same as the original (evaluator's) score, the correspondence score is set to zero.
2) If the user's score is less than the original score, indicating the user estimated the conversation quality was worse than the evaluator's estimate, the correspondence score D is calculated by:
   D=(x−y)*(10/x)
where x is the original score and y is the user score.
3) If the user's score is greater than the original score, the correspondence score D is calculated by:
   D=(y−x)*(10 /(10−x))

This process yields a range-corrected absolute value difference between the original score and the user's score. The resulting correspondence scores can be averaged over the duration of a recorded interaction to provide a relatively long-term, overall assessment or feedback to users. However, the correspondence score can also be used immediately or over a much shorter portion of the conversation to provide real-time feedback to users and to help pinpoint specific areas for improvement.

Non-parametric correspondence estimations based on joystick or mouse or other user input can also be made by examining points during the recorded conversations. An example of this might be where the evaluator's conversation quality score changed by at least 2 out of 10 units in one direction within a 3 second period, although other levels of change and time periods are possible. Such abrupt changes may be referred to as “correspondence checkpoints”. If the user's score changes by, for example, at least 2 units in the same direction, but within 6 seconds, then correspondence may be deemed a 1 or a hit; otherwise, correspondence is 0 or a miss. Non-parametric correspondence can then be calculated as a percentage by dividing the number of hits by the number of correspondence checkpoints and then multiplying by 100.

As described above regarding parametric evaluation, this non-parametric measurement technique can be used over varying time periods to provide either immediate, intermediate, or long-term (historical) assessment or evaluation of the user's performance.

Assessment Mode

The training tool can also be used without feedback in order to assess the user's progress rather than to train the user. For example, the user could view and rate several clips without feedback, and at the end of the session, the tool could cause the user's computer to print or display a text message highlighting strengths or weaknesses in the user's recognition of conversation cues. It may be advantageous to ensure that clips used for this purpose are never used in feedback mode so as to avoid allowing the user to consciously or subconsciously repeat estimates he remembered from a feedback-mode viewing of the same clip.

With the exception of the functions of providing immediate or delayed feedback, the functions described above with reference to teaching mode are fully applicable. Thus, the user being assessed would view clips after all desired modes are selected, and then would provide input to estimate, for example, timing and direction of conversation quality changes (abrupt mode) or continuous quality level (continuous mode).

Assessment data—either current or historical, may then be used to select specific areas of training the user may want to concentrate on, either automatically by the training tool or manually by the user or other individual. For example, the tool could, as the result of an assessment, present the user with (or recommend) a recorded clip that concentrates on nonverbal conversation cues that indicate an unpleasant or low conversation quality.

Exemplary embodiments of the present system have been described above. Those skilled in the art will understand, however, that changes and modifications may be made to these embodiments without departing from the true scope and spirit of the invention, which is defined by the claims. The appended claims are not to be interpreted as including means-plus-function limitations, unless such a limitation is explicitly recited in a given claim using the phrases(s) “means for” and/or “step for.”

1. A method of producing a behavioral training tool, the method comprising:
making a recording of an interaction between a first person and an entity, the recording including information from the first person and the entity;
generating at least one evaluation of the interaction, the evaluation being synchronized to the recorded interaction; and
combining the recording and the at least one evaluation to produce a product.

2. The method of claim 1, wherein the recording includes audio and video information.

3. The method of claim 1, wherein the entity is a second person.

4. The method of claim 1, wherein the evaluation is generated concurrently with the interaction.

5. The method of claim 1, wherein the evaluation is generated subsequent to the interaction.

6. The method of claim 1, wherein the evaluation is continuous.

7. The method of claim 1, wherein the evaluation is directed to discrete portions of the interaction.

8. The method of claim 1, wherein the product comprises a computer readable medium.

9. The method of claim 1, wherein the evaluation is an expert evaluation.

10. The method of claim 1, wherein the evaluation is a participant evaluation.

11. A method of producing a behavioral training tool, the method comprising:
making a recording of an interaction between a first person and a second person, the recording including information from the first person and the second person and further including audio and video information;
generating, subsequent to the interaction, at least one evaluation of the first person and the second person, the evaluation being synchronized to the recorded interaction;
editing the recording to include only at least one discrete portion based on content and based on the evaluation; and
combining the at least one discrete portion of the recording and the at least one evaluation to produce a computer readable medium.

12. A method of behavioral training using a multimedia training tool that includes a recorded interaction and an evaluation of the interaction, the method comprising:
selecting continuous or discrete interaction quality changes to be used to assess a user;
selecting a perspective of the recorded interaction for the user to observe;
starting the multimedia training tool for observation by the user; and
receiving an input from the user, the input representing the user's estimate of at least one quality of the recorded interaction.

13. The method of claim 12, further comprising selecting between video only or full audio and video for the user to observe.

14. The method of claim 12, further comprising selecting between audio only or full audio and video for the user to observe.

15. The method of claim 12, wherein the evaluation of the interaction is an expert evaluation.

16. The method of claim 12, wherein the evaluation of the interaction is a participant evaluation.

17. The method of claim 12, wherein the behavioral training comprises teaching the user by providing feedback to the user based on a comparison of the user input and the evaluation of the interaction.

18. The method of claim 12, wherein the user input represents the user's estimate of singular, pivotal changes in at least one quality of the interaction.

19. The method of claim 12, wherein the user input represents a continuously variable estimate of at least one quality of the interaction.

20. The method of claim 17, wherein the feedback comprises sound.

21. The method of claim 17, wherein the feedback comprises visual feedback.

22. The method of claim 17, wherein the feedback is provided continuously.

23. The method of claim 17, wherein the feedback is provided after all user input is received.

24. The method of claim 23, further comprising:
recording the user input into the multimedia tool; and
operating the multimedia tool to allow the user to synchronously observe the recorded interaction, the user's estimate of the at least one quality of the recorded interaction, and the evaluation of the interaction.

25. The method of claim 12, wherein the behavioral training comprises an aggregate assessment of the user's estimate of at least one quality of a plurality of recorded interactions.

26. The method of claim 12, wherein the user is a plurality of users, the method further comprising:
receiving input from the plurality of users, the input representing the users'estimates of at least one quality of the recorded interaction; and
providing, to a participant in the interaction, feedback based on the users'input.

27. A system for behavioral training comprising:
a processor;
a memory;
a recorded interaction stored in the memory;
an evaluation of the recorded interaction stored in the memory, the evaluation being synchronized to the recorded interaction; and
a set of machine instructions stored in the memory, the instructions being executable by the processor to:
play back the recorded interaction; and
receive an input from the user, the input representing the user's estimate of at least one quality of the recorded interaction.

28. The system of claim 27, wherein the instructions are further executable to receive an input to select continuous or discrete interaction quality changes to be used to assess the user.

29. The system of claim 27, wherein the instructions are further executable to receive an input to cause the selection of a perspective of the recorded interaction for the user to observe.

30. The system of claim 27, wherein the instructions are further executable to receive an input to select between video only, audio only, or full audio and video playback for the user to observe.

31. The system of claim 27, wherein the instructions are further executable to provide feedback to the user based on a comparison of the user input to the evaluation of the interaction.

32. The system of claim 31, wherein the instructions are further executable to:
combine the recorded interaction, the evaluation of the interaction, and the user input; and
simultaneously provide the recorded interaction, the evaluation, and the user's estimate of the at least one quality of the recorded interaction for the user's observation after all the user's input is received.

33. The system of claim 27, wherein the behavioral training comprises an aggregate assessment of the user's estimate of at least one quality of a plurality of recorded interactions.

34. The system of claim 27, wherein the behavioral training comprises teaching the user by providing feedback to the user based on a comparison of the user input and the evaluation of the interaction.
